(19) United States
(12) Patent Application Publication
(10) Pub. No.: US 2010/0169442 A1
(43) Pub. Date: Jul. 1, 2010

(54) APPARATUS AND METHOD FOR PROVIDING PEER-TO-PEER PROXY SERVICE WITH TEMPORARY STORAGE MANAGEMENT AND TRAFFIC LOAD BALANCING IN PEER-TO-PEER COMMUNICATIONS

(75) Inventors: Pin-Chuan Liu, Hsinchu City (TW); Chong-Yie Chang, Changhua County (TW); Chen-Yih Wu, Taichung County (TW); Woei-Luen Shyu, Hsinchu County (TW); Chon-Jei Lee, Kaohsiung County (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/469,641

(22) Filed: May 20, 2009

(30) Foreign Application Priority Data
Dec. 31, 2008 (TW) TW097151757

(51) Int. Cl. G06F 15/16; G06F 15/173

(52) U.S. Cl. 709/206; 709/231; 709/249; 709/223

(57) ABSTRACT

A network gateway device is provided, including a P2P meta-descriptor detector detecting an original P2P meta-descriptor file, a P2P proxy control unit modifying the original P2P meta-descriptor and forwarding the modified P2P meta-descriptor file to a computer, an internal tracker receiving an inquiry message and replying when receiving a response, a storage unit storing shared file segments, an emulated external P2P client loading the original P2P meta-descriptor file, and an emulated internal P2P client performing an internal inquiry procedure and a load balancing procedure, determining whether the storage unit has the shared file segments, wherein if so, the shared file segments are retrieved and forwarded to the computer.

### CROSS REFERENCE TO RELATED APPLICATIONS

This Application claims priority of Taiwan Patent Application No. 97151757, filed on Dec. 31, 2008, the entirety of which is incorporated by reference herein.

### BACKGROUND OF THE INVENTION

1. Field

The invention generally relates to peer-to-peer (P2P) proxy services and, more particularly, to an apparatus and method for providing peer-to-peer proxy services with management of a storage unit and traffic load balancing in peer-to-peer communications.

2. Description of the Related Art

In recent years, peer-to-peer applications, such as BitTorrent and eMule, have grown in popularity. Users from different locations can conveniently download and share electronic files. For conventional architecture, the client-server architecture, there is one uploading source (as a server) which several users (as clients) may download a shared file from. Thus, much burden is placed on the uploading user's system resources and network bandwidth when the number of downloading users increases. On the other hand, for peer-to-peer downloading, take BitTorrent as an example, every downloading user is also uploading parts of the shared file, so that the uploading task may be distributed to every downloading user. In this case, every downloading user can benefit from having more downloading resources when there are more users sharing the same shared file, such as increased downloading speed of the shared file due to more downloading resources. Additionally, fewer burdens are placed on the uploading user's system resources and network bandwidth.

However, for peer-to-peer applications, the number of connections established is far more than that of other downloading applications. Thus, a burden is placed on the network gateway device, such as the broadband gateways for households and small/medium sized enterprises, when being operated. In a private network, each computer connected to a network gateway device is assigned a private network address. When a computer in the private network tries to establish a connection to the public network, the network gateway device performs the network address translation (NAT) procedure to map the private network address to the public network address of the network gateway device. During the NAT procedure, the network gateway device creates a NAT table for storing the mapping information of every incoming and outgoing connection, including source IPs, source port numbers, destination IPs, destination port numbers, mangled IPs, mangled port numbers, and the like.

Among the types of peer-to-peer applications, the bit-stream based peer-to-peer application, also known as BitTorrent (BT), is one of the most popular. For bit-stream based peer-to-peer downloading, there are one or multiple servers that provide torrent files for users from different location to download. The torrent file is a peer-to-peer meta-descriptor including the information of the file to be shared and the information of one or multiple trackers. From the tracker, a user with the torrent file can obtain a list of computers which are sharing the shared file. The user further inquires with the computers on the list whether they're sharing the shared file. The user then downloads the shared file from the computers which reply with a positive response.

FIG. 1 is a block diagram illustrating the NAT table of a network gateway device. As shown in FIG. 1, the network gateway device 130 is connected between a private network 120 and a public network 110. Each incoming or outing packet through a NAT gateway triggers the NAT procedure to replace the original destination IP address of each packet into a proper destination IP address, based on the information on the NAT table. If a computer 121 in the private network 120 executes a BT-like application, the computer 121 must first send an inquiry message to a public tracker 111, according to a torrent file 101, to request for a list of computers that are sharing the desired file. In the BT-like application, a shared file is segmented into pieces in a predetermined piece size. Every piece may be referred to as a shared file segment. The information of the shared file and its every piece is stored in the torrent file 101. With the list, the computer 121 next establishes a connection with a computer 113 to inquire if the computer 113 is sharing the desired file. If so, the computer 121 further requests to download the desired file from the computer 113. The network gateway device 130 performs the NAT procedure for every incoming and outgoing connection, including the connection between the computer 121 and computer 113. Thus, one or multiple mappings for every incoming and outgoing connection are generated and maintained in NAT table 131. For the conventional peer-to-peer communications method, the size of the NAT table 131 grows enormously and occupies much memory space over time. Additionally, much of the CPU's resources must be allocated when searching the NAT table 131 during the NAT procedure. Thus, the performance of the network gateway device 130 decreases significantly when the number of connections increases, especially for peer-to-peer connections.

### SUMMARY

In one embodiment of the invention, a network gateway device connected between a private network and a public network is provided. The network gateway device comprises a peer-to-peer meta-descriptor detector, a peer-to-peer proxy control unit, an internal tracker, a storage unit, an emulated external peer-to-peer client, and an emulated internal peer-to-peer client. The peer-to-peer meta-descriptor detector detects an original peer-to-peer meta-descriptor file from the public network, wherein the original peer-to-peer meta-descriptor file includes information of shared file segments and a network address of a tracker. The peer-to-peer proxy control unit modifies the original peer-to-peer meta-descriptor file by replacing the network address of the tracker with a private network address of an internal tracker to generate a modified peer-to-peer meta-descriptor file, and forwards the modified peer-to-peer meta-descriptor file to a first computer in the private network. The internal tracker generates a download record and a sharing computer list when receiving a first inquiry message from the first computer, sends a request message, and replies to the first computer when receiving a reply message. The storage unit stores the shared file segments to be downloaded. The emulated external peer-to-peer client having an external network address configured to be a public network address of the network gateway device and loads the original peer-to-peer meta-descriptor file. The emulated internal peer-to-peer client having an internal network address configured to be the private network address, performs a first internal inquiry procedure and a load balancing procedure when receiving the request message, sends the reply message according to a return result of the load balancing procedure, determines whether the shared file segments are in the storage unit when requested by the first computer, and retrieves the shared file segments from the storage unit and forwards the shared file segments to the first computer if the shared file segments are in the storage unit.

In another embodiment of the invention, a peer-to-peer communication method for providing peer-to-peer proxy services with management of a storage unit and traffic load balancing in a network gateway device connected between a private network and a public network is provided. The peer-to-peer communication method comprises detecting an original peer-to-peer meta-descriptor file, which is requested by a first computer in the private network, from the public network, wherein the original peer-to-peer meta-descriptor file includes information of shared file segments and a network address of a tracker, loading the original peer-to-peer meta-descriptor file in an emulated external peer-to-peer client, modifying the original peer-to-peer meta-descriptor file by replacing the network address of the tracker with a private network address to generate an modified peer-to-peer meta-descriptor file, forwarding the modified peer-to-peer meta-descriptor file to the first computer in the private network, receiving a first inquiry message from the first computer, wherein the first inquiry message is sent according to the network address of the tracker in the modified peer-to-peer meta-descriptor file, generating a download record and a sharing computer list, performing an internal inquiry procedure, performing a load balancing procedure, and replying to the first computer according to a return result of the load balancing procedure.

In another embodiment of the invention, a peer-to-peer communication method for providing peer-to-peer proxy service with management of a storage unit and traffic load balancing in a network gateway device connected between a public network and at least one private network is provided. The peer-to-peer communication method comprises receiving an inquiry message from a computer in the public network, acquiring a download record, a sharing computer list, and an internal computer list, calculating a first bit-field indicating available shared file segments in the private network according to the inquiry message, the storage unit, the download record, and a mask rule, and replying to the computer in the public network with the first bit-field.

Other aspects and features of the present invention will become apparent to those with ordinarily skilled in the art upon review of the following description of specific embodiments of an apparatus and method for providing peer-to-peer proxy service in peer-to-peer communications.

### BRIEF DESCRIPTION OF DRAWINGS

The invention can be more fully understood by reading the subsequent detailed description and examples with references made to the accompanying drawings, wherein:

FIG. 1 is a block diagram illustrating the NAT table of a network gateway device;

FIG. 2 is a block diagram illustrating an embodiment of providing a peer-to-peer (P2P) proxy service with temporary storage management and traffic load balancing in a network gateway device according to the invention;

FIG. 3 is a flow chart illustrating an embodiment of a peer-to-peer communication method for providing peer-to-peer proxy service and temporary storage management in a network gateway device towards a private network according to the invention; and

FIG. 4 is a flow chart illustrating an embodiment of a peer-to-peer communication method for providing peer-to-peer proxy service and temporary storage management in a network gateway device towards a public network according to the invention.

### DETAILED DESCRIPTION OF THE EMBODIMENTS

The following description is of the best-contemplated mode of carrying out the invention. This description is made for the purpose of illustrating the general principles of the invention and should not be taken in a limiting sense. The scope of the invention is best determined by reference to the appended claims.

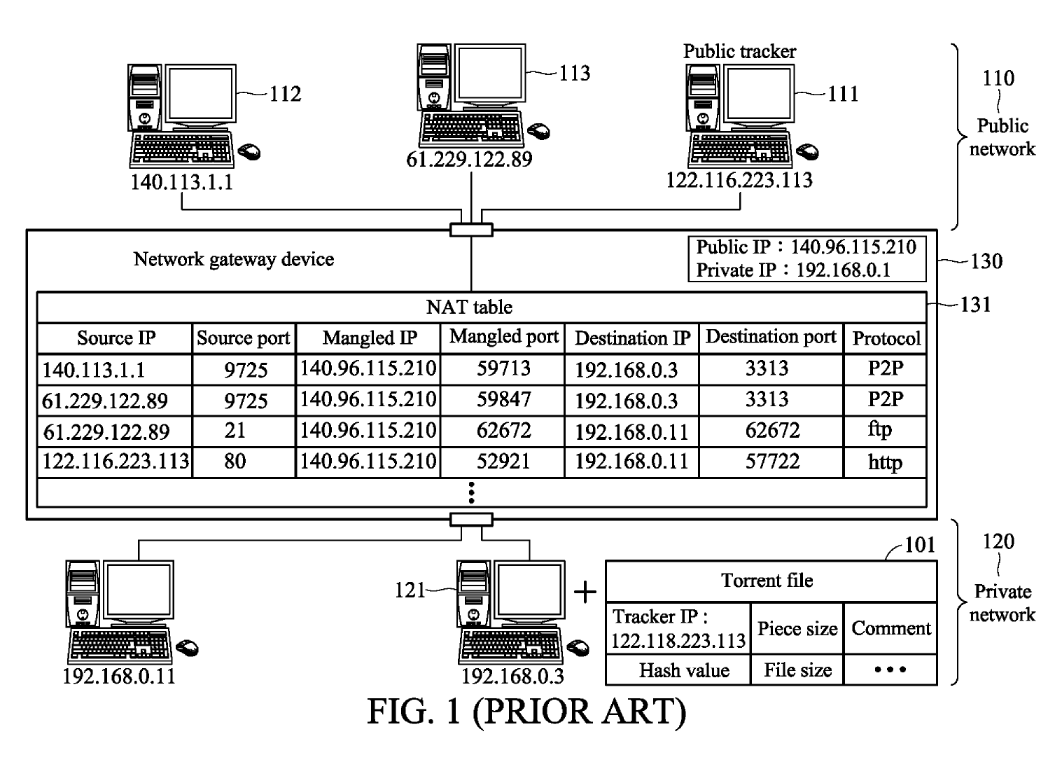

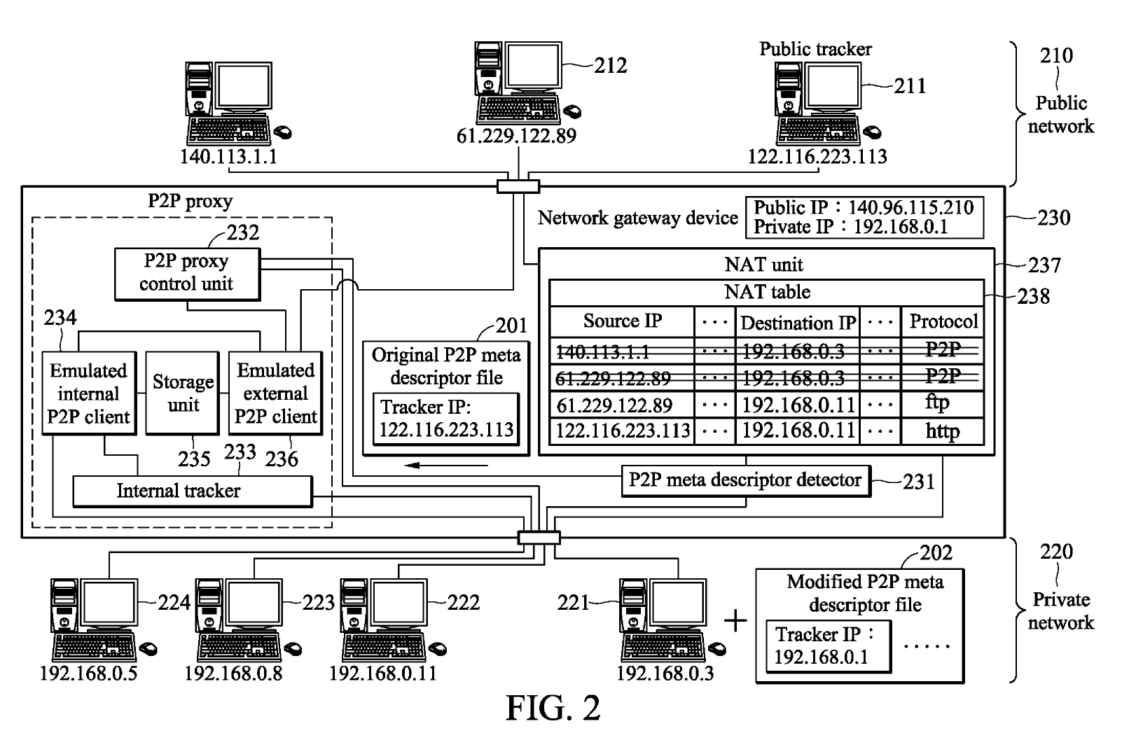

FIG. 2 is a block diagram illustrating an embodiment of providing a peer-to-peer (P2P) proxy service with temporary storage management and traffic load balancing in a network gateway device according to the invention. In this embodiment, a network gateway device 230 is connected between a public network 210 and a private network 220, having a public network address of 140.96.115.210 and a private network address of 192.168.0.1. Unlike other network gateway devices, a broadband gateway device 230 uses a peer-to-peer proxy service to handle all peer-to-peer connections. The network gateway device 230 includes a peer-to-peer meta-descriptor detector 231, a peer-to-peer proxy control unit 232, an internal tracker 233, an emulated internal peer-to-peer client 234, a storage unit 235, an emulated external peer-to-peer client 236, and a network address translation (NAT) unit 237. Compared to FIG. 1, the NAT table 238 in FIG. 2 does not need to store a large amount of connection information generated by the peer-to-peer applications. Besides, the performance of peer-to-peer connections from the private network 220 is increased by the network gateway device 230 providing the storage unit 235 to temporarily store the downloaded shared file segments.

As shown in FIG. 2, the NAT unit 237 generates an internal computer list storing the bandwidth information, upstream traffic records, downstream traffic records, and response times (derived by pining or some other mechanisms) of all the computers in private network 220 when the network gateway device 230 is operated. The NAT unit 237 further performs a network address translation procedure on every peer-to-peer datagram from or to the public network 210. The network address of the emulated internal peer-to-peer client 234 is set as 192.168.0.1, which is the private network address of the network gateway device 230. The network address of the emulated external peer-to-peer client 236 is set as 140.96.115.210, which is the public network address of network gateway device 230.

Before initiating a peer-to-peer connection, the computer 221 in the private network 220 first downloads an original peer-to-peer meta-descriptor file 201 which includes the information of the shared file segments and a network address of a tracker. The peer-to-peer meta-descriptor detector 231 in the network gateway device 230 intercepts the original peer-to-peer meta-descriptor file 201 from the public network 210 and forwards the original peer-to-peer meta-descriptor file 201 to the peer-to-peer proxy control unit 232. The peer-to-peer proxy control unit 232 further forwards the original peer-to-peer meta-descriptor file 201 to the emulated external peer-to-peer client 236, and modifies the original peer-to-peer meta-descriptor file 201 by replacing the network address of the tracker with the network address of the internal tracker 233, which is the private network address, 192.168.0.1, to generate the modified peer-to-peer meta-descriptor file 202, and forwards the modified peer-to-peer meta-descriptor file 202 to the computer 221. Following, the emulated external peer-to-peer client 236 loads the original peer-to-peer meta-descriptor file 201.

With the network address of the tracker from the modified peer-to-peer meta-descriptor file 202, the computer 221 sends a first inquiry message to the internal tracker 233 to inquire about information of the computers which are sharing the shared file segments. When receiving the first inquiry message, the internal tracker 233 generates a sharing computer list and a download record, and sends a request message to the emulated internal peer-to-peer client 234. The sharing computer list stores the network addresses of the computers which are sharing the shared file segments. The download record stores the network information, the information of to-be-shared file segments owned by the downloading computers in the private network 220, the download times of the computers in the private network 220, and the information of file segments owned by computers in the private network 220. When receiving the request message, the emulated internal peer-to-peer client 234 performs a first internal inquiry procedure to inquire if any computer in the private network 220 is sharing the shared file segments, and updates the download record and the sharing computer list according to the result of the first internal inquiry procedure. The emulated internal peer-to-peer client 234 then performs a load balancing procedure to select the computers with less traffic loading from the sharing computer list, and replies to the internal tracker 233 with the information of the selected computers. The internal tracker 233 replies to the computer 221 with the network address of the selected computers and the emulated internal peer-to-peer client 234. From the reply from the internal tracker 233, the computer 221 knows that emulated internal peer-to-peer client 234 is sharing the shared file segments.

The first internal inquiry procedure may comprise the step of inquiring with the specific computers in the private network 220 according to the download record to see if any of the specific computers are sharing the shared file segments, or inquiring with all of the computers in private network 220 according to the internal computer list. The load balancing procedure may comprise the steps of selecting computers from the sharing computer list according to the bandwidth information, the upstream traffic records, the downstream traffic records, or the response times in the internal computer list, selecting computers from the sharing computer list according to the information of to-be-shared file segments owned by the downloading computers in the private network 220, the download times of the computers in the private network 220 in the download record, or selecting computers from the sharing computer list according to the round-robin scheduling rule, and generating a response with the selected computers.

Next, the computer 221 requests the emulated internal peer-to-peer client 234 to download the shared file segments according to the reply from the internal tracker 233. The emulated internal peer-to-peer client 234 then checks to see if the shared file segments are in the storage unit 235. If so, the emulated internal peer-to-peer client 234 retrieves the shared file segments from the storage unit 235 and forwards the shared file segments to the computer 221. If not, one of the following two options can be applied in the network gateway device 230:

Option 1. The emulated internal peer-to-peer client 234 may request the emulated external peer-to-peer client 236 to download the shared file segments from public network 210. Following, the emulated external peer-to-peer client 236 will start to download the shared file segments according to the original peer-to-peer meta-descriptor file 201. The steps of downloading the shared file segments includes first, inquiring with the public tracker 211 about which computer in the public network 210 is sharing the shared file segments and then downloading the shared file segments from the computers in the inquiry result. When finishing the downloading of the shared file segments, the emulated external peer-to-peer client 236 sends an acknowledgement to the emulated internal peer-to-peer client 234 so that the emulated internal peer-to-peer client 234 can further retrieve the shared file segments from the storage unit 235 and forward the shared file segments to the computer 221.

Option 2. The emulated internal peer-to-peer client 234 downloads the shared file segments to the storage unit 235 from the selected computers of the load balancing procedure, retrieves the shared file segments from the storage unit 235, and forwards he shared file segments to the computer 221.

When the storage unit 235 receives a write attempt and its storage has reached a maximum limit, the network gateway device 230 will eliminate the most commonly shared file segments in the public network 210 from the storage unit 235, eliminate the shared file segments with the longest existing time from the storage unit 235, or eliminate the most commonly shared file segments in the private network 210 from the storage unit 235. Moreover, the network gateway device 230 may periodically check the storage unit 235 to eliminate the shared file segments which are no longer needed by any computer in the private network 220 according to the download record and the sharing computer list.

Referring to FIG. 2, the computer 212 in the public network 210 first inquires to the emulated external peer-to-peer client 236 about what shared file segments are shared in the private network 220, before it attempts to download the shared file segments from the private network 220. The emulated external peer-to-peer client 236 obtains a) the information of all of the shared file segments in the private network 220 and b) the information of the stored shared file segments in the storage unit 235, and applies a logical disjunction:

a OR b (1)

Additionally, the emulated external peer-to-peer client 236 further calculate a first bit-field by applying a logical conjunction on (a OR b) and a pre-defined mask rule M:

first bit-field=(a OR b) AND M (2)

The pre-defined mask rule M, can be “to reserve the shared file segments which are the rarest in the public network 210”, or “to filter out the shared file segments which are no longer needed by any computer in the private network 220”. Subsequently, the emulated external peer-to-peer client 236 replies to the computer 212 with the first bit-field.

If the first bit-field indicates that the emulated external peer-to-peer client 236 are sharing the shared file segments, the computer 212 continues to request for downloading the shared file segments from the emulated external peer-to-peer client 236. When receiving the request, the emulated external peer-to-peer client 236 first determines whether the shared file segments are in the storage unit 235. If so, the emulated external peer-to-peer client 236 retrieves the shared file segments from the storage unit 235 and forwards the shared file segments to the computer 212. Otherwise, the emulated external peer-to-peer client 236 requests the emulated internal peer-to-peer client 234 to perform a second internal inquiry procedure. The second internal inquiry procedure comprises the steps of inquiring with the computers in the private network 220 according to the download record or the internal computer list, to see if any of them are sharing the shared file segments, and updating the download record and the sharing computer list. Afterwards, the emulated internal peer-to-peer client 234 performs the load balancing procedure to select the computers with less traffic loading from the sharing computer list. If the return result of the load balancing procedure indicates that no computers in the private network 220 is sharing the shared file segments, the emulated external peer-to-peer client 236 recalculates a second bit-field with the updated download record according to the equations (1) and (2), and replies to the computer 212 with the second bit-field. If the return result of the load balancing procedure indicates that the computers (at least one of computers 221-224) in the private network 220 are sharing the shared file segments, the emulated external peer-to-peer client 236 downloads the shared file segments to the storage unit 235 from the computers 221-224, respectively, and retrieves the shared file segments from the storage unit 235 and forwards the shared file segments to the computer 212.

The load balancing procedure can be manually enabled or disabled by users. That is to say, the step of selecting computers with less traffic loading is skipped and the load balancing procedure responds directly with information of the computers in the sharing computer list. In this case, the network gateway device 230 only provides temporary storage management but not peer-to-peer proxy service.

In other embodiments, the network gateway device 230 may have multiple private network addresses so that the internal tracker 233 and the emulated internal peer-to-peer client 234 can be configured with different private network addresses.

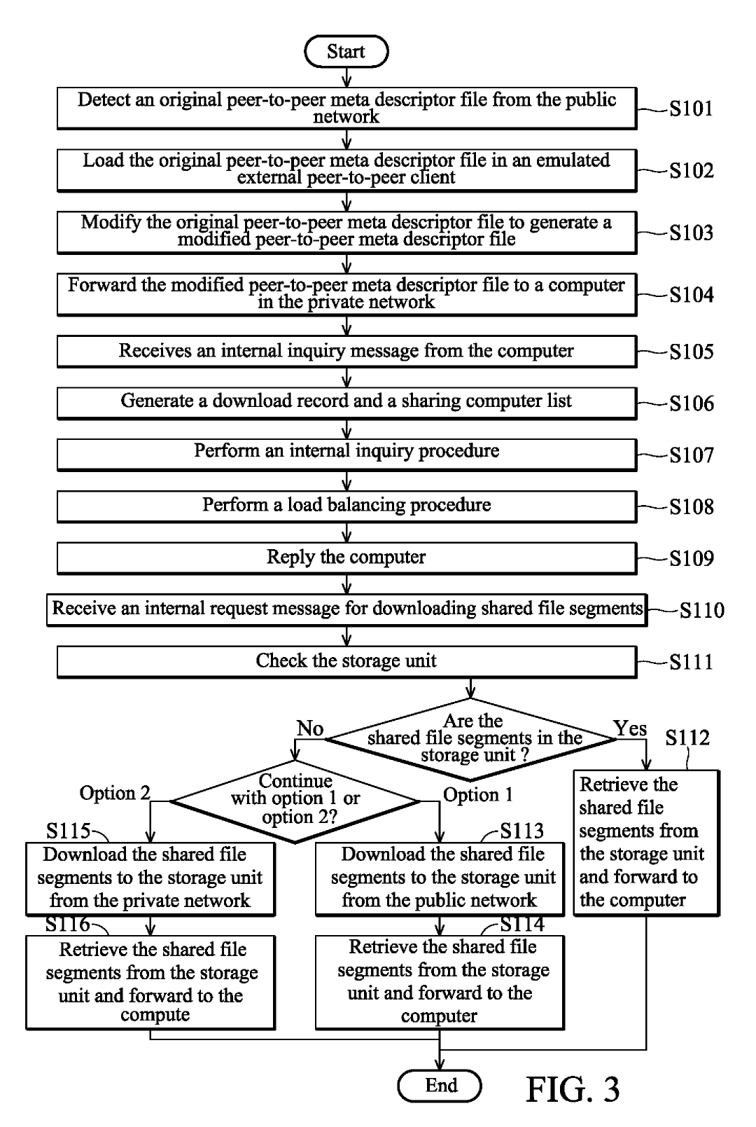

FIG. 3 is a flow chart illustrating an embodiment of a peer-to-peer communication method for providing peer-to-peer proxy service and temporary storage management in a network gateway device towards a private network according to the invention. The process of the method starts with the peer-to-peer meta-descriptor detector 231 detecting an original peer-to-peer meta-descriptor file 201 from the public network 210 (step S101). The peer-to-peer meta-descriptor detector 231 intercepts and forwards the original peer-to-peer meta-descriptor file 201 to the peer-to-peer proxy control unit 232. The peer-to-peer proxy control unit 232 first forwards the original peer-to-peer meta-descriptor file 201 to the emulated external peer-to-peer client 236 so that the emulated external peer-to-peer client 236 loads the original peer-to-peer meta-descriptor file 201 (step S102). The peer-to-peer proxy control unit 232 then modifies the original peer-to-peer meta-descriptor file 201 to generate the modified peer-to-peer meta-descriptor file 202 (step S103), and forwards the modified peer-to-peer meta-descriptor file 202 to the computer 221 in the private network 220 (step S104). After the computer 221 receives the modified peer-to-peer meta-descriptor file 20, it sends an internal inquiry message to the network gateway device 230. Upon receiving the internal inquiry message (step S105), the internal tracker 233 generates a download record and a sharing computer list (step S106). The sharing computer list stores the network addresses of the emulated internal peer-to-peer client 234, which is the private network address of the network gateway device 230, 192.168.0.1. The download record stores the network information, the information of to-be-shared file segments owned by the downloading computers in the private network 220, the download times of the computers in the private network 220, and the information of file segments owned by computers in the private network 220. Next, the emulated internal peer-to-peer client 234 performs an internal inquiry procedure (step S107). The internal inquiry procedure comprises the steps of inquiring with the specific computers in private network 220 according to the download record or the internal computer list, to see if any of the specific computers are sharing the shared file segments, and updating the download record and the sharing computer list. After the internal inquiry procedure is finished, the emulated internal peer-to-peer client 234 continues to perform the load balancing procedure (step S108). The load balancing procedure comprises the steps of selecting computers from the sharing computer list according to the round-robin scheduling rule, the information of to-be-shared file segments owned by downloading computers in the private network 220 or the download times of the computers in the private network 220 in the download record, or the bandwidth information, the upstream traffic records, the downstream traffic records, or the response times in the internal computer list. The network gateway device 230 replies to the computer 221 with the information of the selected computers and the network address of the emulated internal peer-to-peer client 234, which indicates that the emulated internal peer-to-peer client 234 is also sharing the shared file segments (step S109). When receiving the reply, the computer 221 further sends a request message to the network gateway device 230. Upon receiving the request message (step S110), the emulated internal peer-to-peer client 234 determines whether the shared file segments are in the storage unit 235 (step S111). If the shared file segments are in the storage unit 235, the emulated internal peer-to-peer client 234 retrieves the shared file segments from the storage unit 235 and forwards the shared file segments to the computer 221 (step S112), which ends the process. Otherwise, the method can continue with one of the following 2 options: Option 1. The emulated external peer-to-peer client 236 downloads the shared file segments to the storage unit 235 from the public network 210 according to the original peer-to-peer meta-descriptor file 201 (step S113), and retrieves the shared file segments from the storage unit 235 and forwards the shared file segments to the computer 221 (step S114), which ends the process. Option 2. The emulated internal peer-to-peer client 234 downloads the shared file segments to the storage unit 235 from the selected computers of the load balancing procedure (step S115), and retrieves the shared file segments from the storage unit 235 and forwards the shared file segments to computer 221 (step S116), which ends the process.

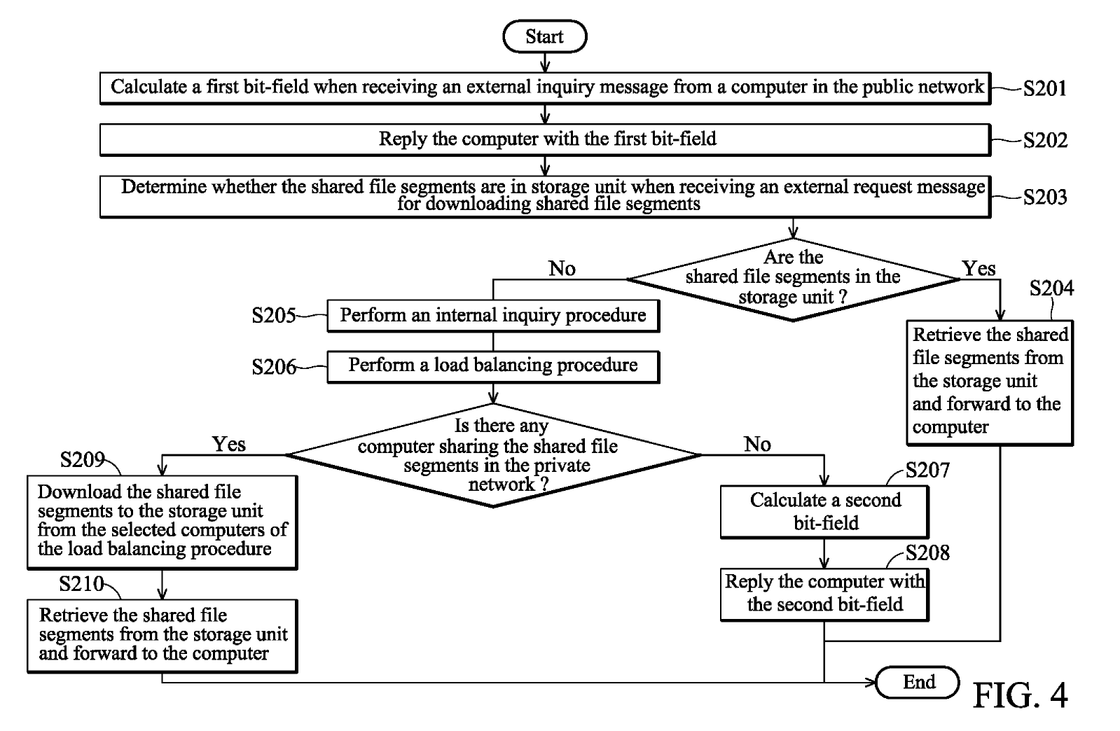

FIG. 4 is a flow chart illustrating an embodiment of a peer-to-peer communication method for providing peer-to-peer proxy service and temporary storage management in a network gateway device towards a public network according to the invention. In this embodiment, the computer 221 is operating peer-to-peer communications through the method specified in FIG. 3. The computer 212 in the public network 210 obtains the information of the network gateway device 230 from the public tracker 211. The process of the method starts with the computer 212 sending an external inquiry message to the network gateway device 230. Upon receiving the external inquiry message, the emulated external peer-to-peer client 236 calculates a first bit-field (step S201) with the download record, the storage unit 235, and a mask rule M, according to the equations (1) and (2), and replies to the computer 212 with the first bit-field (step S202). The mask rule M, can be “to reserve the shared file segments which are the rarest in the public network 210”, or “to filter out the shared file segments which are no longer needed by any computer in the private network 220”.

When receiving the reply, the computer 212 sends an external request message to the network gateway device 230 for downloading the shared file segments. Upon receiving the external request message, the emulated external peer-to-peer client 236 determines whether the shared file segments are in the storage unit 235 (step S203). If the shared file segments are in the storage unit 235, the emulated external peer-to-peer client 236 then retrieves the shared file segments from the storage unit 235 and forwards the shared file segments to the computer 212 (step S204), which ends the process. Otherwise, emulated internal peer-to-peer client 234 performs an internal inquiry procedure (step S205). The internal inquiry procedure comprises the steps of inquiring with the specific computers in the private network 220 according to the download record or the internal computer list, to see if any of the specific computers are sharing the shared file segments, and updating the download record and the sharing computer list. After the internal inquiry procedure is finished, the emulated internal peer-to-peer client 234 continues to perform a load balancing procedure (step S206). The load balancing procedure comprises the steps of selecting computers from the sharing computer list according to the round-robin scheduling rule, the information of to-be-shared file segments owned by the downloading computers in the private network 220 or the download times of the computers in the private network 220 in the download record, or the bandwidth information, the upstream traffic records, the downstream traffic records, or the response time in the internal computer list, and generating a response with the selected computers. If the return result of the load balancing procedure indicates that there is no computer in the private network 220 sharing the shared file segments, the emulated external peer-to-peer client 236 calculates a second bit-field (step S207) with the updated download record, the storage unit 235, and the mask rule M, according to equations (1) and (2), and replies to the computer 212 with the second bit-field (step S208), which ends the process. If the return result of the load balancing procedure indicates that there are computers (at least one of computers 221-224) sharing the shared file segments in the private network 220, the emulated internal peer-to-peer client 234 downloads the shared file segments to the storage unit 235 from the selected computers of the load balancing procedure (step S209), and retrieves the shared file segments from the storage unit 235 and forwards the shared file segments to the computer 212 (step S210), which ends the process.

The peer-to-peer communication methods in FIG. 3 and FIG. 4 further comprises the steps of eliminating the most commonly shared file segments in the public network 210 from the storage unit 235, eliminating the shared file segments with the longest existing time from the storage unit 235, or eliminating the most commonly shared file segments in the private network 210 from the storage unit 235, when the storage unit 235 receives a write attempt and its storage has reached a maximum limit. Moreover, the peer-to-peer communication methods comprises periodically checking the storage unit 235 to eliminate the shared file segments which are no longer needed by any computer in the private network 220 according to the download record and the sharing computer list.

The load balancing procedure of the peer-to-peer communication methods can be manually enabled or disabled by users. That is to say, the step of selecting the computers with less traffic loading may be skipped and the load balancing procedure may responds directly with information of the computers in the computer sharing list. In this case, the network gateway device 230 only provides temporary storage management and not peer-to-peer proxy service.

In other embodiments, the network gateway device 230 may have multiple private network addresses so that the internal tracker 233 and the emulated internal peer-to-peer client 234 can be configured with different private network addresses.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A network gateway device connected between a private network and a public network, comprising:
a peer-to-peer meta-descriptor detector detecting an original peer-to-peer meta-descriptor file from the public network, wherein the original peer-to-peer meta-descriptor file includes information of shared file segments and a network address of a tracker;
a peer-to-peer proxy control unit modifying the original peer-to-peer meta-descriptor file by replacing the network address of the tracker with a private network address to generate an modified peer-to-peer meta-descriptor file, and forwarding the modified peer-to-peer meta-descriptor file to a first computer in the private network;
an internal tracker generating a download record and a sharing computer list when receiving a first inquiry message from the first computer, sending a request message, and replying to the first computer when receiving a reply message;
a storage unit storing the shared file segments to be downloaded;
an emulated external peer-to-peer client having an external network address configured to be a public network address of the network gateway device and loading the original peer-to-peer meta-descriptor file; and
an emulated internal peer-to-peer client having an internal network address configured to be a private network address of the network gateway device, performing a first internal inquiry procedure and a load balancing procedure when receiving the request message, sending the reply message according to a return result of the load balancing procedure, determining whether the shared file segments are in the storage unit when requested by the first computer, and retrieving the shared file segments from the storage unit and forwarding the shared file segments to the first computer if the shared file segments are in the storage unit.

2. The network gateway device of claim 1, wherein the download record stores downloading computer information, information of to-be-shared files owned by downloading computers in the private network, download times of computers in the private network, or information of file segments owned by computers in the private network, and the sharing computer list stores network addresses of the computers which are sharing the shared file segments.

3. The network gateway device of claim 1, further comprising a network address translation unit generating an internal computer list, wherein the internal computer list stores network address information of computers in the private network, bandwidth information, upstream traffic records, downstream traffic records, and response times.

4. The network gateway device of claim 3, wherein the first internal inquiry procedure comprises inquiring if any computer in the private network is sharing the shared file segments indicated in the first inquiry message according to the download record or the internal computer list, and updating the download record or the internal computer list when receiving replies from computers in the private network.

5. The network gateway device of claim 1, wherein the load balancing procedure comprises selecting computers from the sharing computer list according to a round-robin scheduling rule or from the sharing computer list according to the information of owned file segments and the download times in the download record, and generating the return result of the load balancing procedure with information of the selected computers.

6. The network gateway device of claim 3, wherein the load balancing procedure comprises selecting computers from the sharing computer list according to the bandwidth information, the upstream traffic records, the downstream traffic records, or the response times in the internal computer list, and generating the return result of the load balancing procedure with information of the selected computers.

7. The network gateway device of claim 1, wherein the load balancing procedure is disabled in response to a user input, and generates the return result with the information of computers in the sharing computer list, which are sharing the shared file segments indicated in the first inquiry message.

8. The network gateway device of claim 1, wherein the emulated internal peer-to-peer client further requests the emulated external peer-to-peer client to download the shared file segments from the public network to the storage unit in response to that the shared file segments are not in the storage unit, retrieves the downloaded shared file segments from the storage unit, and forwards the shared file segments to the first computer.

9. The network gateway device of claim 1, wherein the emulated internal peer-to-peer client further downloads the shared file segments from computers indicated in the return result of the load balancing procedure to the storage unit in response to that the shared file segments are not in the storage unit, retrieves the downloaded file segments from the storage unit, and forwards the downloaded file segments to the first computer.

10. The network gateway device of claim 1, wherein the emulated external peer-to-peer client further calculates a first bit-field indicating available shared file segments in the private network according to the storage unit, the download record, a mask rule, and a second inquiry message from a second computer in the public network, and replies to the second computer with the first bit-field.

11. The network gateway device of claim 10, wherein the mask rule is to reserve the shared file segments which are the rarest in the public network, or to filter out the shared file segments which are no longer needed by computers in the private network.

12. The network gateway device of claim 10, wherein the emulated external peer-to-peer client further determines whether the shared file segments are in the storage unit when requested by the second computer, and retrieves the shared file segments from the storage unit and forwards the shared file segments to the second computer if the shared file segments are in the storage unit.

13. The network gateway device of claim 12, wherein the emulated external peer-to-peer client further requests the emulated internal peer-to-peer client to perform a second internal inquiry procedure and the load balancing procedure if the shared file segments are not in the storage unit.

14. The network gateway device of claim 13, wherein if the return result of the load balancing procedure indicates that no computer in the private network is sharing the shared file segments, the emulated external peer-to-peer client further calculates a second bit-field according to the storage unit, the download record, and the mask rule, and replies to the second computer with the second bit-field, wherein the second bit-field indicates updated available shared file segments in the private network.

15. The network gateway device of claim 13, wherein if the return result of the load balancing procedure indicates that the shared file segments are being shared in the private network, the emulated external peer-to-peer client further requests the emulated internal peer-to-peer client to download the shared file segments from the private network to the storage unit according to the return result of the load balancing procedure, retrieves the shared file segments from the storage unit, and forwards the shared file segments to the second computer.

16. The network gateway device of claim 13, wherein the second internal inquiry procedure comprises inquiring if any of the computers in the download record or the internal computer list is sharing the shared file segments, and updating the download record and the sharing computer list.

17. The network gateway device of claim 1, wherein the shared file segments in the storage unit are managed when the storage unit receives a write attempt failure due to storage unit full, according to one of the following elimination rules:
eliminate the shared file segments which are most common in the public network;
eliminate the shared file segments with the longest existing time; or eliminate the shared file segments which are most common in the private network.

18. The network gateway device of claim 1, wherein the shared file segments in the storage unit are periodically checked according to the download record and the sharing computer list, to eliminate the shared file segments which are no longer needed by computers in the private network.

19. A peer-to-peer communication method for providing peer-to-peer proxy service with management of a storage unit and traffic load balancing in a network gateway device connected between a private network and a public network, comprising:
detecting an original peer-to-peer meta-descriptor file, which is requested by a first computer in the private network, from the public network, wherein the original peer-to-peer meta-descriptor file includes information of shared file segments and a network address of a tracker;
loading the original peer-to-peer meta-descriptor file into an emulated external peer-to-peer client;
modifying the original peer-to-peer meta-descriptor file by replacing the network address of the tracker with a private network address to generate an modified peer-to-peer meta-descriptor file;
forwarding the modified peer-to-peer meta-descriptor file to the first computer in the private network;
receiving a first inquiry message from the first computer, wherein the first inquiry message is sent to the network address of the tracker in the modified peer-to-peer meta-descriptor file;
generating a download record and a sharing computer list;
performing an internal inquiry procedure;
performing a load balancing procedure; and
replying the first computer according to a return result of the load balancing procedure.

20. A peer-to-peer communication method for providing peer-to-peer proxy service with management of a storage unit and traffic load balancing in a network gateway device connected between a public network and at least one private network, comprising:
receiving an inquiry message from a computer in the public network;
calculating a first bit-field indicating available shared file segments in the private network according to the inquiry message, shared file segments in the storage unit, the download record, a sharing computer list, an internal computer list, and a mask rule; and
replying to the computer in the public network with the first bit-field.

21. The peer-to-peer communication method of claim 20, further comprising determining whether the shared file segments are in the storage unit when requested by the computer in the public network, and retrieving the shared file segments from the storage unit and forwarding the shared file segments to the computer in the public network if the shared file segments are in the storage unit.

22. The peer-to-peer communication method of claim 21, further comprising performing an internal inquiry procedure and a load balancing procedure if the shared file segments are not in the storage unit, and calculating a second bit-field and replying to the computer in the public network with the second bit-field if a return result of the load balancing procedure indicates that the shared file segments are not shared by computers in the private network, wherein the second bit-field indicates available shared file segments in the private network and is calculated according to the storage unit, the download record, and the mask rule.

23. The peer-to-peer communication method of claim 22, further comprising if the return result of the load balancing procedure indicates that the shared file segments are shared by computers in the private network,
downloading the shared file segments from the private network to the storage unit according to the return result of the load balancing procedure;
retrieving the shared file segments from the storage unit; and
forwarding the shared file segments to the computer in the public network.

24. The peer-to-peer communication method of claim 22, wherein the internal inquiry procedure comprises inquiring if any computer in the private network is sharing the shared file segments, according to the download record or the internal computer list, and updating the download record and the sharing computer list when receiving replies from the computers in the private network.

25. The peer-to-peer communication method of claim 22, wherein the load balancing procedure comprises selecting computers from the sharing computer list according to a round-robin scheduling rule or from the sharing computer list according to information of owned file segments and download time in the download record or bandwidth information, upstream traffic records, downstream traffic records, and response times in the internal computer list, and generating the return result with information of the selected computers.

26. The peer-to-peer communication method of claim 22, wherein the load balancing procedure is disabled in response to a user input, and generates the return result with the information of computers, which are sharing the shared file segments requested by the computer in the public network, in the sharing computer list.
